(19) United States
(12) Patent Application Publication
(10) Pub. No.: US 2025/0382885 A1
(43) Pub. Date: Dec. 18, 2025

(54) GUIDE VANE ELEMENT FOR A COMPRESSOR OF A TURBOMACHINE, GUIDE VANE CLUSTER AND TURBOMACHINE

(71) Applicant: MTU Aero Engines AG, München (DE)

(72) Inventors: Dennis Von Brauneck, München (DE); Roland Wunderer, Haimhausen (DE); Franz-Josef Ertl, München (DE)

(73) Assignee: MTU Aero Engines AG, München (DE)

(21) Appl. No.: 19/227,715

(22) Filed: Jun. 4, 2025

(30) Foreign Application Priority Data
Jun. 12, 2024 (DE) 10 2024 116 479.4

(51) Int. Cl. F01D 5/14

(52) U.S. Cl. CPC F01D 5/143; F05D 2220/323; F05D 2240/24

(57) ABSTRACT

The invention relates to a guide vane element for a compressor of a turbomachine, comprising an airfoil and a shroud arranged at a radially outer end of the airfoil, wherein, on an outer radial side, the shroud has a fastening section for connecting to a housing of the turbomachine; on a radial inner side, the shroud has an inner surface which, in a sectional view perpendicular to the circumferential direction, has at least one elevation projecting radially inward; and the inner surface of the shroud has a longer axial extension than the axial width of the airfoil.

### BACKGROUND OF THE INVENTION

The invention relates to a guide vane element for a compressor of a turbomachine, a guide vane cluster and a turbomachine.

Direction indications such as “axial” or “axial”, “radial” or “radial” and “circumferential” are generally to be understood as referring to the machine axis of the turbomachine, unless the context explicitly or implicitly indicates otherwise.

It is known that regions are provided in the so-called annular channel of a turbomachine that are raised compared to an ideal annular space geometry, and these can be, for example, cylindrical or conical, i.e. to protrude into the annular channel to positively influence the flow conditions in the annular channel.

For example, the document DE 10 2016 211 315 A1 discloses a vane, particularly a turbine stage of a gas turbine, in particular an aircraft gas turbine, having a vane root and an airfoil connected to the vane root, wherein the airfoil has a pressure side and a suction side, and wherein the vane root has at least one raised region on its radial outer side facing the airfoil. The teaching of the document proposes that the vane has a first raised region on the pressure side and a second raised region on the suction side, wherein the highest point of the first raised region is arranged essentially directly adjacent to the pressure side, and the highest point of the second raised region is essentially arranged directly adjacent to the suction side.

### SUMMARY OF THE INVENTION

It is an object of the invention to further improve the flow conditions, particularly to avoid secondary flows such as channel vortices. Furthermore, it is an object of the invention to provide a guide vane element that is simple and inexpensive to manufacture.

The invention is based on the idea of providing a guide vane element for a compressor of a turbomachine, wherein the guide vane element is extended in the upstream direction with respect to the airfoil and thus has an axial width that is significantly greater than the axial width of the airfoil. This provides more design flexibility and a simple way to provide the inner surface of the annular space with a sidewall contouring in a cost-effective manner.

The invention provides a guide vane element for a compressor of a turbomachine, comprising an airfoil and a shroud arranged at a radially outer end of the airfoil, wherein the shroud has a fastening section on a radially outer side for connection to a housing of the turbomachine; the shroud has an inner surface on a radially inner side, which in a sectional view perpendicular to the circumferential direction, has at least one radially inward projecting elevation, and the inner surface of the shroud has a longer axial extension than the axial width of the airfoil.

In other words, the guide vane element has at least one airfoil and has the shroud at its radially outer end. The shroud has an airfoil root that is designed as a platform and has an annular construction along the circumferential direction of the turbomachine to annularly delimit the flow region toward the outside. The shroud is accordingly arranged at a radially outer end of the blade and has a fastening section on its outer side for connection to a liner or to the housing of the turbomachine. On its radially inner side, the shroud has an inner surface that delimits the flow region to the radially outward side and is thus in direct contact with the flowing fluid during operation. The inner surface of the shroud can also be referred to as the outer wall of the annular space. Furthermore, the inner surface has at least one inwardly projecting elevation or depression in a sectional view perpendicular to the circumferential direction, i.e., in a sectional plane along the axial direction and along the radial direction, which makes it possible to influence the flow in such a way that secondary flows can be reduced. This distinguishes the inner surface from, for example, a conical surface, and accordingly has an elevation and/or a depression located between the upstream and downstream edges of the inner surface. This design, which differs from a cylindrical or conical configuration of the inner surface, is also referred to as sidewall contouring.

The sidewall contouring helps the flow to be better guided during operation, to improve the flow onto the airfoil, and to reduce losses of the turbomachine, for example due to turbulent vortices. Furthermore, since the housing is usually rotationally symmetrical, an aerodynamically favorable flow onto the blade can be easily achieved with the help of sidewall contouring of the guide vane element. In particular, the inner surface of the guide vane element or shroud is larger in the axial direction than the axial width of the airfoil. This can improve the inflow of the flow medium onto the blade, since sidewall contouring can be performed upstream of the airfoil. Furthermore, an axial surface for the contouring can be increased, thus improving the efficiency of the sidewall contouring.

Furthermore, the shroud extension can lengthen a leakage path formed between the housing and the shroud along the fastening section. A longer leakage path can reduce leakage flow during operation due to greater resistance compared to a guide vane element that does not have the shroud extension.

Furthermore, the shroud extension can provide greater mechanical stability of the guide vane element, and this increased mechanical stability can improve fatigue strength (high cycle and low cycle (HCF/LCF) fatigue performance). Furthermore, the performance during surging can generally be improved, as the guide vane element exhibits greater stability.

The invention has further exemplary embodiments which provide additional advantages.

According to a further advantageous embodiment example, the fastening section has at least one undercut for the form-fitting connection to the housing in the radial direction. In other words, the fastening section can be designed to be hook-shaped so that it can be held in a positive-locking manner by the outer housing or the liner. This embodiment therefore has the advantage that the guide vane element is held by positive connection, and no further fastening, such as bolts or screws, are required to connect it to the outer housing.

According to a further advantageous embodiment example, it is envisaged that the axial extension of the shroud is longer than the axial extension of the fastening section. In other words, the shroud has a greater axial length than the fastening section formed on the outer side of the shroud. Thus, the leakage path can be extended in a particularly advantageous manner, and a special supporting effect of the shroud relative to the housing or liner can be achieved. The shroud can preferably protrude beyond the vane edge either upstream or downstream by at least 5% of the axial blade width; preferably, the shroud can protrude by at least 10%, particularly preferably by at least 12.5%.

According to a further advantageous embodiment example, the shroud extends beyond the fastening section in the upstream direction. In other words, the shroud extends in the upstream axial direction with respect to the extension of the fastening section and protrudes beyond the fastening section. This results in a special supporting effect of the shroud against the housing, the leakage path is extended, and vibrations of the guide vane element can be reduced. In particular, the rigidity of the guide vane element can be increased, so that fatigue strength (HCF/LCF performance) can be favorably influenced.

According to a further advantageous embodiment example, the shroud extends beyond the airfoil in the upstream direction and is designed in such a way that it projects into a recess in the housing when assembled. In other words, the shroud extends in the upstream direction relative to the airfoil and can project into a recess in the housing. Thus, the inner surface of the shroud can be designed, for example, such that it steplessly connects to the inner surface of the housing or liner. Thus, the guide vane element can be designed in a particularly advantageous manner to favorably influence inflow of the airflow.

According to a further advantageous embodiment example, it is provided that the shroud has an extension in the upstream direction, which has a grooved surface on the radially outward side. In other words, the shroud extension described above is referred to as an extension section, which has radially outward grooves that are formed along the circumferential direction. The guide vane element is thus designed to engage in corresponding grooves in the housing to achieve a particularly advantageous extension of the leakage path. This can increase the flow resistance in the leakage flow and thereby improves the efficiency of the turbine by reducing the leakage flow past the airfoil.

According to a further advantageous embodiment example, the guide vane element is formed in one piece with the airfoil and the shroud, in particular by an additive manufacturing process. In other words, the guide vane element can be produced, for example, from a single cast or forged part. Furthermore, the guide vane element can be produced, for example, by machining, whereby the shroud and the airfoil are formed as a single unit with the guide vane element. In a particularly preferred embodiment, a particularly advantageous and cost-effective production of the guide vane element is possible by an additive manufacturing process or a 3D printing process.

According to a further aspect of the invention, a guide vane cluster for a turbomachine, in particular a gas turbine, is provided with a guide vane element according to the above description, wherein the guide vane element has at least two airfoils arranged adjacent to one another in the circumferential direction and connected to one another via the shroud. In other words, the guide vane element can, for example, have two, three, four, five, or even more airfoils and can have a shroud that connects the blades arranged adjacent to one another in the circumferential direction. The guide vane element can be designed in segments and can form a guide vane ring with additional guide vane elements, which, together with a rotor blade wheel, forms a stage of a turbomachine, in particular a gas turbine or a compressor of a gas turbine. By manufacturing a guide vane cluster, in particular by the additive manufacturing process, a particularly cost-effective production of the guide vane element can be achieved.

According to another aspect of the invention, a turbomachine, in particular a gas turbine for an aircraft engine, is provided, wherein the turbomachine comprises at least one guide vane element according to the above description and/or at least one guide vane cluster according to the above description.

According to another advantageous embodiment example, it is envisaged that the housing of the turbomachine has a step in the radial direction and the housing is designed to accommodate the shroud of the guide vane element according to the above description such that an inner surface of the housing steplessly connects to the inner surface of the shroud. As there is no step at the transition from the housing (or the liner), vortices can be avoided during operation, and a particularly preferred flow pattern can be achieved.

### BRIEF DESCRIPTION OF THE DRAWING FIGURES

The invention is described below with reference to the accompanying figures by way of example and is not limiting.

Shown here:

FIG. 1 shows a schematic sectional view of a guide vane element according to the prior art; and

FIG. 2 shows a schematic sectional view of a guide vane element according to the technology disclosed here.

### DESCRIPTION OF THE INVENTION

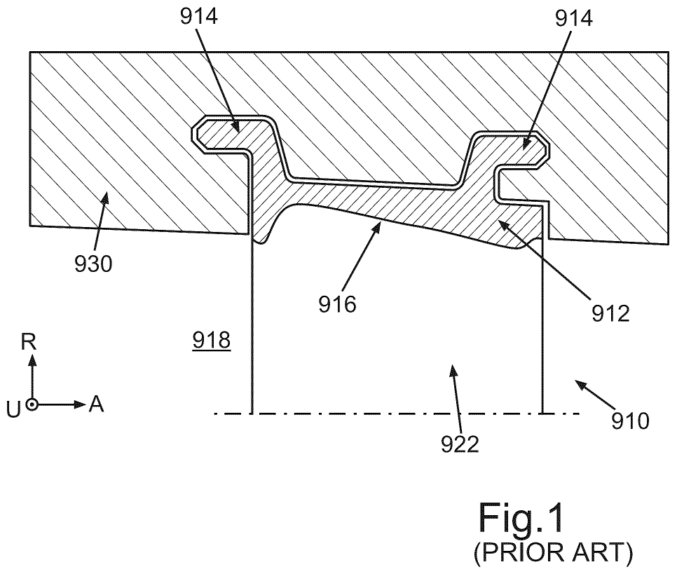

FIG. 1 shows a guide vane element 910 according to the prior art in a schematic sectional view perpendicular to the circumferential direction U. The guide vane element 910 comprises a shroud 912, a fastening section 914, an inner surface 916, and an airfoil 922. The guide vane element 910 is inserted into the housing 930 and is held by the housing 930 in a form-fitting manner. The flow region 918 is located in the lower part of FIG. 1, i.e., radially inward in the turbomachine. The sectional view is shown perpendicular to a circumferential direction, and an axial direction A lies in the left-right direction in FIG. 1. A leakage path is present between the guide vane element 910 and the housing 930, which allows a flowing fluid to bypass the airfoil 922 along the gap between the guide vane element 910 and the housing 930. Fluid flow along the leakage path therefore does not contribute to the efficiency of the turbomachine.

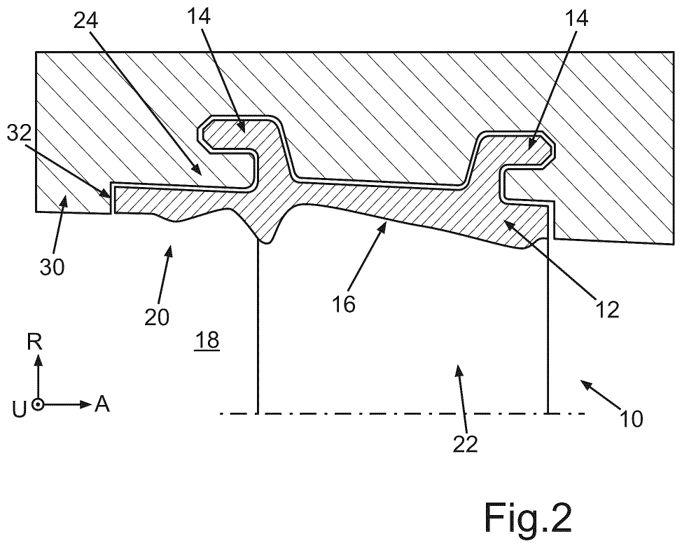

FIG. 2 shows, in a schematic view similar to FIG. 1, a guide vane element 10 according to the technology disclosed here. The guide vane element 10 comprises a shroud 12, a fastening section 14, an inner surface 16, an extension section 20 and an undercut 24. The guide vane element 10 thus extends upstream in the axial direction A to include the extension section 20. The airfoil 22 has a smaller extension in the axial direction A than the shroud 12, which the extension section 20 lengthens when compared to the guide vane element 910 according to FIG. 1. At its radially outer end, the guide vane element 10 has a fastening section 14 which, according to FIG. 2, includes an undercut 24. The fastening section 14 can be designed, according to FIG. 2, in the form of two hook-shaped projections, which enables the housing 30 to hold the guide vane element 10 in a form-fitting manner. The housing 30 can also be a liner that holds one or more guide vane elements 10 in segments and is inserted and secured into the housing after the guide vane elements 10 have been attached. The fastening section 14 thus serves as a form-fitting connection to the turbomachine housing 30.

The airfoil 22 has shroud 12 at its radially outer end. The shroud 12 has the inner surface 16 on its radially inner side. This inner surface 16 is also referred to as sidewall contouring because it has a contouring that distinguishes the inner surface from an ideal cylindrical shape or from a conical shape. The inner surface 16 is an outer wall of the annular space that delimits the flow region 18 through which the fluid flows during operation and is thus in direct contact with the flowing fluid during the operation of the turbomachine. According to the technology disclosed here, the inner surface 16 has at least one elevation projecting on the radially inward side. The inner surface 16 has a longer axial extension than the axial width of the airfoil 22. Furthermore, the axial extension (the extension in the axial direction A) of the inner surface 16 is greater than the axial extension of the fastening section 14 for a positive locking connection to the housing 30. Furthermore, the shroud 12 projects beyond the fastening section 14 in the upstream direction. Furthermore, it can be seen in FIG. 2 that the shroud 12 projects beyond the blade 22 in the upstream direction. Furthermore, the shroud 12 projects into a recess in the housing 30, which has step 32. In other words, the housing 30 has a step 32 in the radial direction R. This results in a stepless connection between the inner surface of the housing 30 to the inner surface of the shroud 12. The guide vane element 10 is advantageously formed in one piece to include the shroud 12 and the airfoil 22.

According to an advantageous embodiment example, the guide vane element 10 is formed by an additive manufacturing process and thus advantageously requires only minimal rework. For this purpose, the guide vane element can be constructed from a trailing edge (in the flow direction) to a leading edge or from the leading edge to the trailing edge. Furthermore, the additive manufacturing process requires less material. If the guide vane element 10 has several airfoils 22 that are adjacent to one another and connected to one another via the shroud 12, this is referred to as a guide vane cluster for the turbomachine. Manufacturing the guide vane cluster using the additive manufacturing process results in additional cost advantages. Furthermore, the guide vane cluster can advantageously achieve greater mechanical stability. Nevertheless, the guide vane element according to the invention and the guide vane cluster according to the invention can be assembled in the usual way. Advantageously, the turbomachine is a gas turbine for an aircraft engine.

The leakage path formed between the guide vane element 10 and the housing 30 is, as shown in FIG. 2, extended by the extension section 20 compared to FIG. 1, so that resistance through the leakage path is increased and leakage flow through the leakage path is correspondingly reduced. It should be noted that the leakage path can advantageously be further extended by providing grooves and projections on the shroud, for example, on its outer side that engage with corresponding grooves or recesses in the housing 30.

The sidewall contouring of the inner surface 16 can be used to achieve a particularly aerodynamically favorable flow to the airfoil 22. Since the guide vane element 10 is particularly easy to manufacture through additive manufacturing, it is possible to achieve an aerodynamically favorable flow to the airfoil 22 in a particularly simple manner.

What is claimed is:

1. A guide vane element for a compressor of a turbomachine, comprising:
an airfoil and a shroud arranged on a radially outer end of the airfoil;
on a radially outer side, the shroud has a fastening section for connection to a housing of the turbomachine;
on a radially inner side, the shroud has an inner surface, which has at least one radially inward projecting elevation and/or a radially outward indented depression in a sectional view perpendicular to the circumferential direction;
wherein the inner surface of the shroud has a longer axial extension compared to the axial width of the airfoil.

2. The guide vane element according to claim 1, wherein the fastening section has at least one undercut for the form-fitting connection to the housing in the radial direction.

3. The guide vane element according to claim 1, wherein the shroud has a longer axial extension than an axial extension of the fastening section.

4. The guide vane element according to claim 1, wherein the shroud projects beyond the fastening section in the upstream and/or the downstream direction.

5. The guide vane element according to claim 1, wherein the inner surface of the shroud protrudes by at least 5% of the axial width of the airfoil upstream and/or downstream beyond the respective blade edge.

6. The guide vane element according to claim 1, wherein the shroud projects beyond the airfoil in the upstream direction and is configured and arranged to project into a recess of the housing when assembled.

7. The guide vane element according to claim 1, wherein the shroud has an extension section in the upstream direction, which has a grooved surface on its radially outward side.

8. The guide vane element according to claim 1, wherein the guide vane element is formed in one piece with the airfoil and the shroud by an additive manufacturing process.

9. A turbomachine for an aircraft engine, with at least one guide vane element according to claim 1.

10. The turbomachine according to claim 9, wherein the housing has a step in the radial direction, and the housing is configured and arranged to receive the shroud of the guide vane element such that an inner surface of the housing steplessly connects to the inner surface of the shroud.
